(19) United States
(12) Patent Application Publication
(10) Pub. No.: US 2013/0151251 A1
(43) Pub. Date: Jun. 13, 2013

(54) AUTOMATIC DIALOG REPLACEMENT BY REAL-TIME ANALYTIC PROCESSING

(71) Applicants: William S. Herz, Hayward, CA (US); Carl K. Wakeland, Scotts Valley, CA (US)

(72) Inventors: William S. Herz, Hayward, CA (US); Carl K. Wakeland, Scotts Valley, CA (US)

(73) Assignee: ADVANCED MICRO DEVICES, INC., Sunnyvale, CA (US)

(21) Appl. No.: 13/316,730

(22) Filed: Dec. 12, 2011

(51) Int. Cl. G10L 15/26

(52) U.S. Cl. 704/235; 704/E15.045

(57) ABSTRACT

An automated method and apparatus for automatic dialog replacement having an optional I/O interface converts an A/V stream into a format suitable for automated processing. The I/O interface feeds the A/V stream to a dubbing engine for generating new dubbed dialog from said A/V stream. A dubber/slicer replaces the original dialog with the new dubbed dialog in the A/V stream. The I/O interface then transmits the A/V stream that is enhanced with a new dubbed dialog.

### FIELD OF INVENTION

The present invention relates to audio dubbing and more specifically to automated audio dubbing using analytic processing in real time.

### BACKGROUND

Often there are many situations in which the speech content of movies, video games or other multimedia includes material that is not suitable for all audiences. Presently, care providers, parents and public institutions, such as libraries and schools, rely on indicators from the content provider as to the maturity level of the material including the speech content. These indicators can be in the form of visually perceptible labels, such as rating indicators printed on the outside of physical copies of the media or displayed on the screen of video device before or during playback. Many content providers provide legal/societal restrictions of content distribution or viewership in the form of ratings systems. Furthermore, these indicators may be provided in the form of machine readable code, such that a device enabled to check for such codes and restrict mature material from younger viewers would switch off the audio and video upon such a code. This is also referred to as channel blocking for which a known standard is commonly referred to as the V-chip.

Other techniques, include, but are not limited to, manual censoring with time delay which is often used for live broadcasts. Versions of media content edited for general audiences such as for in-flight movies use known censoring methods to mute or “bleep” offensive words or re-dub entire words or phrases. These techniques presently use automated dialog replacement (ADR) in post-production. However, it should be noted that “automated dialog replacement” provides automation support only for the audio substitution process, not for the creation of replacement audio, which must be recorded manually in a studio.

Such solutions, while fit for their intended purpose, rely on the content provider to provide a suitable method for determining the maturity level of the content or to provide an adequate copy of the material suitable for general audiences. With the advent of the Internet and the ability to stream media content through the Internet, video sharing services now allow for anyone to become a content provider. In such instances, media from diverse sources are now readily accessible to anyone with no or minimal content censorship. In such instances, the solutions provided by the content providers in the past are not adequate for ensuring content may be delivered to general audiences.

Thus the need exists for a way to deliver audio media content that is suitable for general audiences.

### SUMMARY OF EMBODIMENTS

Some embodiments disclosed include an automated method and apparatus for automatic dialog replacement having an optional I/O interface for converting an A/V stream into a format suitable for automated processing. The I/O interface feeds the A/V stream to a dubbing engine for generating new dubbed dialog from said A/V stream. A dubber/slicer replaces the original dialog with the new dubbed dialog in the A/V stream. The I/O interface then transmits the A/V stream that is enhanced with a new dubbed dialog.

### BRIEF DESCRIPTION OF THE DRAWING(S)

Other aspects, advantages and novel features of the invention will become more apparent from the following detailed description of the invention when considered in conjunction with the accompanying drawings wherein:

FIG. 1 is a block diagram of an automatic dialog replacement according to the present invention;

FIG. 2 is a block diagram of an automatic dialog replacement according to an alternate embodiment of the present invention; and

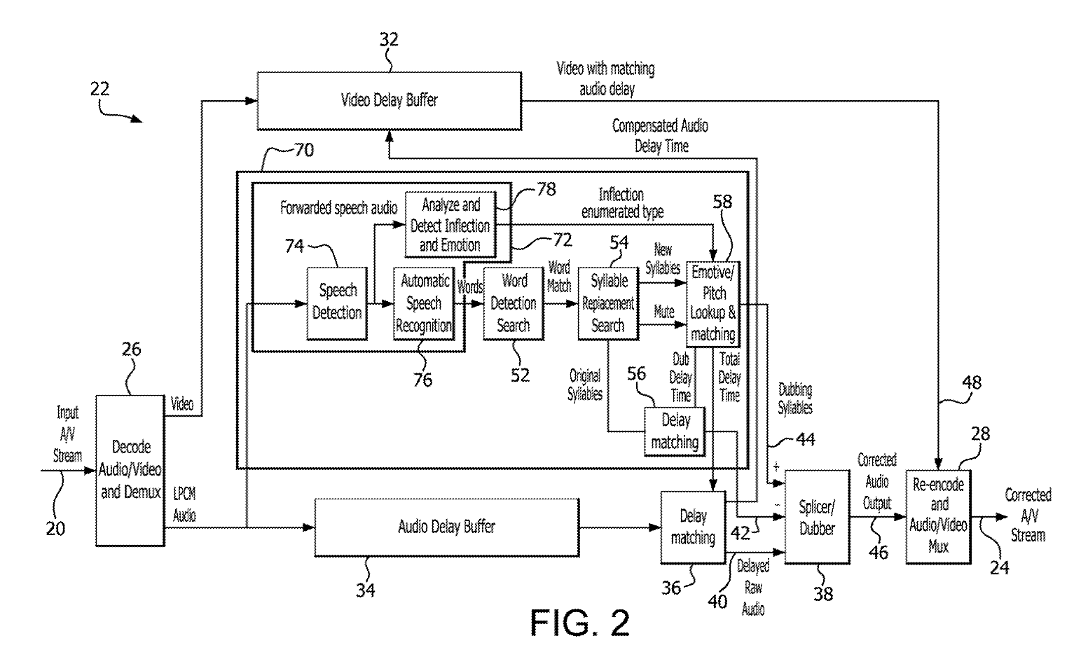

FIG. 3 is a block diagram of an exemplary device in which one or more disclosed embodiments may be implemented.

### DETAILED DESCRIPTION OF THE PREFERRED EMBODIMENT(S)

The present invention relates to an automatic dialog replacement system for use in the delivery of multimedia content to an end-user. Live or recorded speech in media content including, but not limited to, streamed media content, cable and broadcast television, video on demand (VOD), media storage devices, such as digital video disks (DVDs) and Blu-Ray™ disks, and gaming software may contain unsuitable or offensive language. An automatic real-time dialog replacement apparatus provides a convenient parental control method and provides for viewing and/or streaming of content without concern for violating cultural norms.

With reference to the Figures for purposes of illustration, a preferred embodiment of the present invention is capable of being deployed at any point in a video stream between a multimedia source and a destination, such as a final conversion of the multimedia into a perceptible form. As such, the present invention is described in the context of being along the audio/video (A/V) stream wherein the incoming audio/video (A/V) stream 20 enters the apparatus 22 and the processed A/V stream 24 with edited audio exits to continue on to its destination. The input/output (I/O) interface 26 and 28 of the apparatus 22 may vary according to the position of the apparatus in the A/V stream and the format of the content being analyzed. For purposes of illustration a single A/V stream of A/V content is received by demux/decoder 26 to convert the stream into separate audio and video components, which are in turn processed by a mux/encoder 28 to output the A/V stream in the same format it was received in. Those skilled in the art will appreciate that the I/O interface 26 and 28 as described is merely intended to show that the present invention is not limited to the separate audio and video streams as used by the apparatus, but may include any format that may be converted into separate audio and video streams.

In general terms, the process flow is divided into at least two paths, namely, a dubbing engine 30 to automatically detect and replace speech, and buffered memory including a video delay buffer 32 and an audio delay buffer 34 to hold raw video and audio, respectively, content during processing of the dubbing engine 30. The stream is demultiplexed (if required) and the audio decoded into a format in which it may be analyzed and processed, typically linear pulse-coded modulation (LPCM) by the input interface 26. The video may also be decoded into a format that allows for transfer to a matching delay in buffered memory to maintain lip-sync with the audio, and for image processing within the dubbing engine 30 in a preferred embodiment.

The raw decoded LPCM audio is also passed to an audio delay buffered memory 34 and to the dubbing engine 30. The purpose of the audio delay buffer 34 and video delay buffer 32 and a delay matching engine 36 is to match the delay of the raw audio stream to be re-dubbed to the time needed to produce new dialog with dubbed computer generated speech enhancements output from the dubbing engine 30. The delay matching engine 36 receives an indicator from the dubbing engine 30 when dubbed dialog is ready to be output and notifies the Audio Delay Buffer 34 and Video Delay Buffer 32 of the amount of delay in the dubbing engine output. The delay matching engine 36 then passes the raw audio to a splicer/dubber 38 that receives the stream 40 of raw audio track, a stream 42 containing original dialog terms to be extracted from the raw audio track stream 40 and a stream 44 of new dubbed dialog (which may, in certain circumstances, be blanks, bleeps or other non-speech). The splicer/dubber 38 edits the raw audio stream 40 by deleting the original dialog terms stream 42 and replaces it with the new dubbed dialog stream 44. As will be appreciated, a configuration setting (set, in some embodiments, by a user) will allow for different dialog terms or subsets of dialog terms to be deleted from the original audio stream. In this manner, different configurations are possible to delete different terms from the same original audio stream depending upon the configuration (set, for example, by the user). The enhanced audio stream 46 is then transferred to the output interface 28 and is synchronized with the video as a processed A/V stream 24.

It will be appreciated by those skilled in the art that the audio and video delay buffers 34 and 32 and internal delay tracking within the dubbing engine 30 in combination with the delay matching engine 36 provides all of the components for the A/V stream in synch with each other. This controlled delivery of these A/V stream components allows for a simple mixing engine in the splicer/dubber 38 that operates on similar principles as dialog separation processing. The previously isolated dialog vocal stems to be redubbed are subtracted from the original soundtrack by inverting the isolated voice and adding it to the delay-matched original sound. The replacement dialog is thusly mixed in.

The dubbing engine 38 includes a speech detection and recognition engine 50 that uses audio or audio and video cues to strip out dialog from the overall audio stream and detect the words and syllables spoken as well as the emotional inflections used by the speaker to deliver the spoken words. Words derived from the speech detection and recognition engine 50 are compared to a database of words or phrases considered unsuitable for general audiences in a word detection search engine 52. The undesirable word sounds are sent to a syllable replacement engine 54 that finds terms similar to the original words and searches for new words that match the context of the dialog and the syllable pattern of the original word.

If no term is found, a mute or bleep tone is added to the dialog. The original dialog terms are sent to a dub delay matching buffer 56 that matches the time delay of the original dialog terms that are to be deleted from the audio to the time and phase of any new dubbed dialog that is generated. The same time delay is also applied to the original audio using delay matching buffer 36. The output of the syllable replacement engine 54 provides either the new syllables or other censor indicators such as a mute or bleep tone to an emotive/pitch and matching engine 58 that enhances the dubbed dialog with the speech inflections used in the original dialog to match with emotive and pitched speech that comes with emotion and tone. The output of the emotive/pitch and matching engine 58 is the new dubbed dialog that is delivered to the splicer/dubber 38.

The speech detection and recognition engine 50 uses a speech detection engine 60 to extract speech content in the raw stream. A speech detection engine of the type suitable for this purpose is Voice Trap, Ver 2.0c, manufactured by Trevor Magnusson of Hobart, Australia and sold at cloneensemble.com. This extraction allows the remainder of the audio signal flow to focus only on speech processing without the interference of other sounds in the source audio.

The first processing step on the speech audio entails the parallel implementation of an automatic speech recognition (ASR) engine 62 and emotive/inflection analytics engine 64. An ASR engine of the type suitable for this purpose is the Loquendo ASR, version 7.10 manufactured by Loquendo S.p.A. of Torino, Italy. The emotive/inflection analytics engine 64 provides the emotive tone input to that is used by the emotive/pitch and matching engine 58 match the emotive tone of the overall dialog. An emotive/pitch and matching engine of the type suitable for this purpose is included in the Calabrio Speech Analytics 2.0 application manufactured by Calabrio, Inc. of Minneapolis, Minn.

To support and enhance the accuracy of the ASR engine 62, an automated lip-reading (ALR) engine 66 receives the video stream and uses lip detection and other visual cues from the audio to detect the speech. An ALR delay matching engine 67 synchronizes the speech detected from the ALR engine with the speech detected from the ASR engine. Computerized ALR engines of this type, such as the ALR software used by Frank Hubner of Germany, have used lip reading detect speech along a 160 degree range of viewing angles. An ALR system of the type suitable for this purpose is disclosed in U.S. Pat. No. 4,975,960 to Petajan, which is incorporated herein by reference. The video lip detection may optionally be performed in parallel with audio-based ASR engine 62, and the results combined within the ASR engine 62 in a voting process. The voting process would compare the word cues provided from ALR engine 66 with the concurrent ASR engine 62 decoding of the corresponding speech sounds. The output of the speech recognition process is a stream of enumerated, decoded words.

In a second embodiment, where like reference numerals refer to like elements, a dubbing engine 70 is includes a speech detection and recognition engine 72 having a speech detection engine 74, ASR engine 76 and emotive/inflection analytics engine 78. The speech detection and recognition engine 72 avoids using the processing of video to detect speech.

It will be appreciated by those skilled in the art that the present invention may be included in graphics/sound cards and used by graphics processing units and audio processing units to enhance the consumer's choice for selected audio. Furthermore, such an apparatus may be included as a stand alone device to a television or audio device or may be included in, but not limited to, a television, cable set top box, DVD, digital video player (DVP) or digital video recorder (DVR). Furthermore, it will be appreciated that where the A/V stream is delivered remotely from the user the facility receiving the A/V stream such as a school or library as well as the ISP or content provider of live video may use this apparatus to provide an A/V stream that has been modified for general audiences.

It may be appreciated that with the Internet enabled devices that one or more of the apparatus engines may be processed remotely from the other components. Engines that may be suitable for such distributed processing may include, but are not limited to, processing of the speech detection and recognition engine which may include additional processing power as well as the word detection search engine which may benefit from a remote database that is more easily updated with new terms. Distributed computing solutions of this type are commonly referred to as cloud computing, where cloud computing relies on sharing computing resources over a network such as the Internet rather than having local servers or personal devices to handle applications.

It will further be appreciated that with such distributed processing of apparatus components that delay matching engines used by the present invention may be augmented or replaced by time coding added to the audio and video streams to account loss of timing synchronization that is incumbent with distributed processing systems.

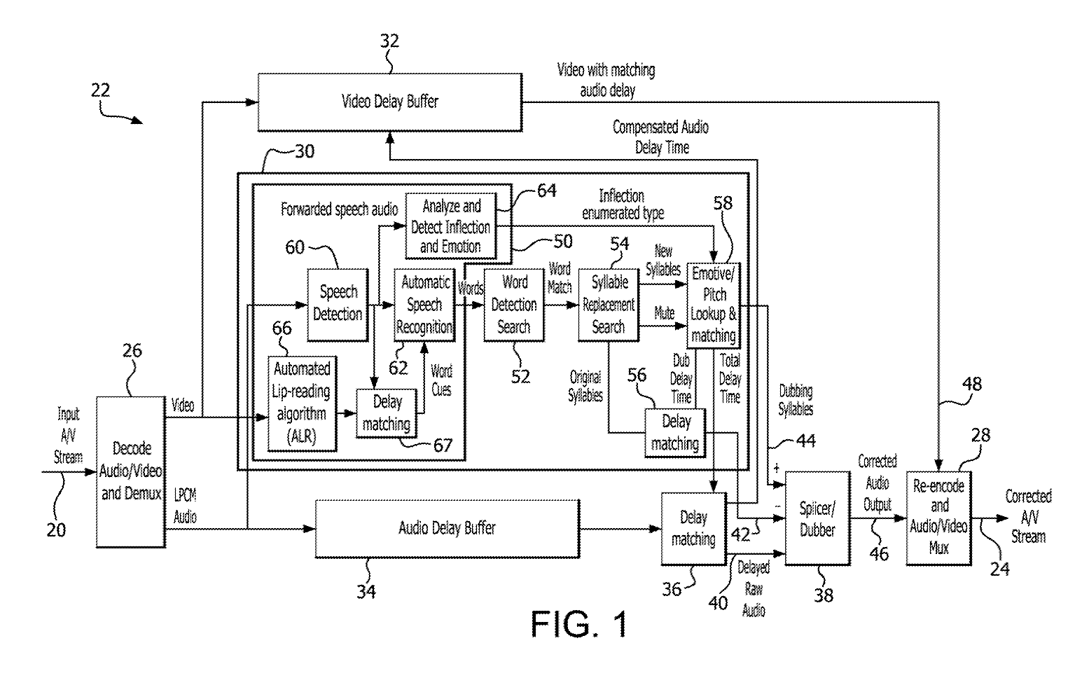

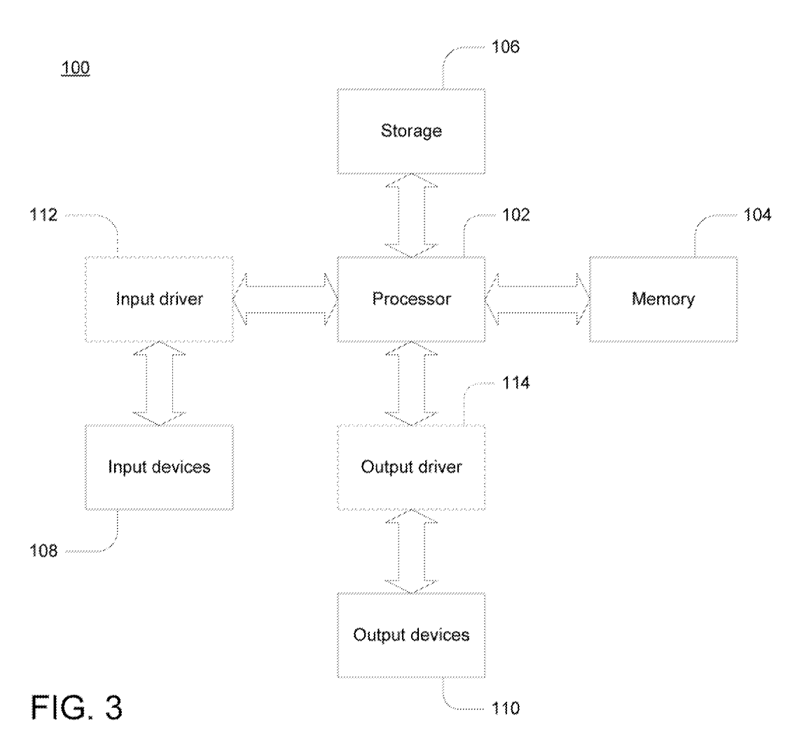

FIG. 3 is a block diagram of an exemplary device 100 in which one or more disclosed embodiments may be implemented. The device 100 may include, for example, a computer, a gaming device, a handheld device, a set-top box, a television, a mobile phone, a tablet computer or video driver card for use in another device. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), an audio processing unit (APU), a CPU and GPU and/or APU located on the same die, or one or more processor cores, wherein each processor core may be a CPU, APU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner is the input driver 112 and the output driver 114 are not present.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An automated system for automatic dialog replacement comprising:
a dubbing engine for generating new dubbed dialog from said A/V stream from a source; and
a dubber/slicer for replacing original dialog with said new dubbed dialog in said A/V stream.

2. The system of claim 1 wherein said dubbing engine includes:
a speech detection and recognition engine to convert speech from said A/V stream to text along with determining a tone of the speech;
a word detection search engine for detecting word terms to be dubbed;
a syllable replacement engine for finding suitable replacement words; and
an emotive/pitch and matching engine to match the dubbed voice to the tone of the dialog;
wherein dubbed speech is generated for insertion in said A/V stream.

3. The system of claim 2 wherein said speech detection and recognition engine includes an automatic speech recognition engine for converting audio speech to text.

4. The system of claim 2 wherein said speech detection and recognition engine includes an automatic lip reading engine for converting visual facial movements from speech to text.

5. The system of claim 2 wherein said speech detection and recognition engine includes a speech detection engine for separating speech from an audio stream.

6. The system of claim 2 wherein said speech detection and recognition engine includes an emotive/pitch and matching engine for analyzing speech to determine the context of the speech relative to pitch and emotion.

7. The system of claim 2 wherein said speech detection and recognition engine includes:
a speech detection engine for separating speech from an audio stream
an automatic speech recognition engine for converting audio speech to text;
an automatic lip reading engine for converting visual facial movements from speech to text;
said automatic lip reading engine generates text to compare with text created by automatic speech recognition engine by said automatic speech recognition engine; and
an emotive/pitch and matching engine for analyzing speech to determine the context of the speech relative to pitch and emotion.

8. A method for automatic dialog replacement comprising the steps of:
generating a new dubbed dialog using a dubbing engine from said A/V stream;
replacing original dialog with said new dubbed dialog in said A/V stream using a dubber/slicer; and
transmitting said A/V stream that is enhanced with a new dubbed dialog.

9. The method of claim 8 wherein said generating a new dubbed dialog step includes:
converting speech from said A/V stream to text along with determining a tone of the speech;
detecting word terms to be dubbed;
finding suitable replacement words using syllable replacement; and
matching the dubbed voice to the emotive tone of the dialog;
wherein dubbed speech is generated for insertion in said A/V stream.

10. The method of claim 9 wherein said converting step includes converting audio speech to text.

11. The method of claim 9 wherein said converting step includes converting visual facial movements from speech to text.

12. The method of claim 9 wherein said converting step includes separating speech from an audio stream.

13. The method of claim 9 wherein said converting step includes analyzing speech to determine the context of the speech relative to pitch and emotion.

14. The method of claim 9 wherein said converting step includes:
separating speech from an audio stream
converting audio speech to text;
converting visual facial movements from speech to text;
comparing text created from visual facial movements with text created from audio speech to select a preferred conversion; and
analyzing speech to determine the context of the speech relative to pitch and emotion.

15. A computer readable non-transitory medium including instructions which when executed in a processing system cause the system to replace dialog, the replacing of dialog comprising:
converting at an I/O interface an A/V stream into a format suitable for automated processing;
generating a new dubbed dialog using a dubbing engine from said A/V stream from said I/O interface;
replacing original dialog with said new dubbed dialog in said A/V stream using a dubber/slicer; and
transmitting said A/V stream that is enhanced with a new dubbed dialog from said I/O interface.

16. The computer readable non-transitory medium of claim 15 including instructions wherein said generating a new dubbed dialog step includes:
converting speech from said A/V stream to text along with determining a tone of the speech;
detecting word terms to be dubbed;
finding suitable replacement words using syllable replacement; and
matching the dubbed voice to the emotive tone of the dialog;
wherein dubbed speech is generated for insertion in said A/V stream.

17. The computer readable non-transitory medium of claim 16 including instructions wherein said converting step includes converting audio speech to text.

18. The computer readable non-transitory medium of claim 16 including instructions wherein said converting step includes converting visual facial movements from speech to text.

19. The computer readable non-transitory medium of claim 16 including instructions wherein said converting step includes separating speech from an audio stream.

20. The computer readable non-transitory medium of claim 16 including instructions wherein said converting step includes:
separating speech from an audio stream
converting audio speech to text;
converting visual facial movements from speech to text;
comparing text created from visual facial movements with text created from audio speech to select a preferred conversion; and
analyzing speech to determine the context of the speech relative to pitch and emotion.
